(19) United States
(12) Patent Application Publication
(10) Pub. No.: US 2025/0313149 A1
(43) Pub. Date: Oct. 9, 2025

(54) MOUNTABLE SKYLIGHT ASSEMBLY AND INSTALLATION THEREOF

(71) Applicant: Tramec, L.L.C., Shawnee, KS (US)

(72) Inventor: Kevin M. Cornelius, Kansas City, MO (US)

(21) Appl. No.: 19/170,904

(22) Filed: Apr. 4, 2025

Related U.S. Application Data
(60) Provisional application No. 63/631,914, filed on Apr. 9, 2024.

(51) Int. Cl. B60Q 3/51; B60Q 3/30; B60Q 3/60

(52) U.S. Cl. CPC B60Q 3/51; B60Q 3/30; B60Q 3/60

(57) ABSTRACT

A skylight assembly and method of installing may include a first portion having a lens and a first annular wall defining a central axis and having at least one securing tab. The assembly may include a second portion having at least one detent configured to engage with at least a portion of the securing tab. The method of installing may include inserting the first portion of the skylight assembly into an aperture. The method of installing may include rotating the second portion of the skylight assembly onto an annular wall of the first portion.

### CROSS-REFERENCE TO RELATED APPLICATIONS

This application claims priority to U.S. Provisional Patent Application No. 63/631,914 filed on Apr. 9, 2024, which is incorporated by reference herein in its entirety.

### TECHNICAL FIELD

The disclosure generally relates to a skylight assembly, and more specifically to a skylight assembly for a vehicle wall, particularly to a vehicle wall of a truck body or tractor trailer.

### BACKGROUND

Illumination within commercial trailers and truck bodies allows the driver or others to more readily navigate the typically dark interior and notably improves visibility when viewing, loading, and unloading any freight being carried. Improved visibility allows a user to visually monitor freight materials and accurately pick and move items during loading and unloading while backed up to a dock.

Typically, dry freight commercial trailers and dry freight truck bodies are illuminated either by an opaque fiberglass roof, dome lights, or artificial lights from within the building it is docked with aimed from the back of the vehicle. However, fiberglass roofs are susceptible to breakage over time as adverse weather effects, such as the accumulation of heavy snow, or because of long-term UV exposure, which can degrade the material. Aluminum roofs and roof skins are preferably employed for their durability but block light from entering the vehicle interior.

Dome lights or other artificial light options can provide illumination but can introduce concerns, particularly as these light options often draw current from a vehicle's auxiliary power circuit. In the case of a trailer, as the vehicle's auxiliary power circuit is relied upon to power other essential operational systems, notably, the antilock braking system (ABS), dome lights and artificial lights accidentally left illuminated during transit may draw power away from essential systems and can, in turn, diminish the effectiveness of the vehicle's ABS braking system or other essential systems. The addition of timers and switches to these lights can better manage this consumption of current; however, supplemental components—timers, switches, the lamps themselves, wiring—can be costly to install and maintain. Harvesting sunlight is ideal for daytime operation and installing one or more skylight assemblies along the body of vehicle is an advantageously low-cost solution for illuminating the vehicle interior.

Skylight assembly installation can be done by purchasing a skylight assembly installation kit and either newly-installing a skylight or replacing an existing skylight in the vehicle wall. Present installation kits on the market offer assemblies usable only to a limited range of wall thicknesses. In particular, fleets commonly employ a variety of vehicle brands in their pool of trailers and are burdened by stocking varying assembly kits to accommodate the assortment of wall thicknesses that exist across different brands, or even different models of a given brand.

Further, aftermarket skylight assembly installation kits require more than one person to mount the skylight assembly. Typically, two individuals—one outside the vehicle on a ladder and one inside the vehicle on a ladder—are required to install each skylight, which may increase costs and hinder business efforts.

Present efforts for more convenient skylight installations lack structure for providing a watertight seal with the vehicle interior and loosen over time with the natural vibrations experienced by the vehicle during transit, which can detrimentally expose the vehicle interior and transported cargo to outside elements and contaminants.

The purpose of the example disclosed herein is to offer a cost-effective and reliable solution that enables a single person to readily couple a skylight to a vehicle wall with a secure and watertight connection therebetween.

### BRIEF DESCRIPTION OF THE DRAWINGS

FIG. 1 is a perspective view of a tractor trailer having a trailer with a sidewall and a skylight assembly installed along that sidewall according to one example.

FIG. 2 is a perspective view of the skylight assembly of FIG. 1.

FIG. 3 is a perspective exploded view of the skylight assembly from FIG. 1 including a lens portion and a retainer.

FIG. 4 is a perspective view of the lens portion from FIG. 3 according to one example.

FIG. 5A is a perspective view of the retainer from FIG. 3 according to one example.

FIG. 5B is a perspective view of a retainer for the skylight assembly of FIG. 1 according to another example.

FIG. 6 is a perspective view across a plane of an opening in the sidewall of the trailer of FIG. 1 showing the lens portion with a gasket positioned on one side of the opening.

FIG. 7 is a perspective view in the same orientation shown with respect to FIG. 6, with the gasket positioned on a flange of the lens portion.

FIG. 8 is a perspective view in the same orientation shown with respect to FIG. 7, with the retainer being positioned axially with respect to the inserted lens portion on an opposite side of the opening in the sidewall.

FIG. 9 is a perspective view in the same orientation shown with respect to FIG. 8, with a portion of the lens portion engaged with a portion of the retainer.

FIG. 10 is perspective view in the same orientation shown with respect to FIG. 9, illustrating a suitable tool having a bit for providing rotational movement to the retainer with respect to the lens portion.

FIG. 11 is perspective view in the same orientation shown with respect to FIG. 10, with a torque-limiting portion of the retainer shown detached from a remainder of the retainer due to rotation imparted by the suitable tool.

FIG. 12 is a profile view of the skylight assembly from FIG. 3 showing a final assembly configuration of the skylight assembly shown in FIGS. 6-11 within the opening in the sidewall.

FIG. 13 is a flow chart illustrating a method of installing the skylight assemblies described herein according to one example.

FIG. 14 is a perspective exploded view of a skylight assembly for the tractor trailer of FIG. 1 according to another example.

FIG. 15 is a perspective view of a top of a retainer of the skylight assembly from FIG. 14.

FIG. 16 is a perspective view of a lens portion of the skylight assembly according.

FIG. 17 is a perspective view of a bottom of the retainer of the skylight assembly from FIG. 15.

FIG. 18 is a profile view of the skylight assembly from FIG. 14 showing a final assembly configuration of the skylight assembly shown in FIGS. 14-17 within the opening in the sidewall.

FIG. 19 is a flow chart illustrating a method of installing the skylight assemblies described herein according to one example.

### DETAILED DESCRIPTION

Aspects of the disclosure described herein are directed to a skylight assembly. More specifically, a skylight assembly for installation along a vehicle wall. For purposes of illustration, the present disclosure will be described with respect to a tractor trailer, or semi-trailer, and the application of a skylight assembly mounted along the sidewall of a trailer. In other examples, the skylight assembly as disclosed herein may be installed in a wall (e.g. a sidewall or a roof) of a truck body. It will be understood, however, that aspects of the disclosure described herein are not so limited and may have general applicability within other mobile applications and non-mobile industrial, commercial, and residential applications.

The example is capable of other embodiments and of being practiced or of being carried out in various ways.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are used solely for identification purposes to aid the reader's understanding of the present disclosure, and should not be construed as limiting on an embodiment, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references are not utilized to conclude do not necessarily infer that two elements are directly connected and in fixed relation to one another. The exemplary drawings are for purposes of illustration only and the dimensions, positions, order, and relative sizes reflected in the drawings attached hereto can vary.

Various embodiments of the example are shown in the attached drawings, descriptions contained in the drawings are specifically incorporated herein by reference.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

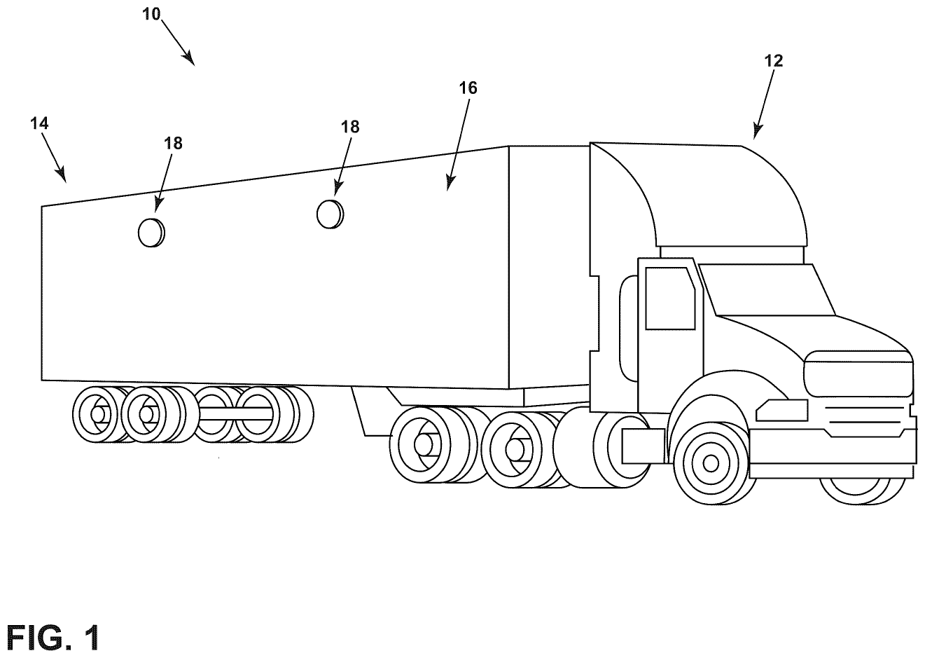

FIG. 1 illustrates a tractor trailer 10 including a tractor 12 and a trailer 14. A sidewall 16 defines at least a portion of the trailer 14. The sidewall 16 includes multiple skylight assemblies 18 according to one example. It will be understood by one skilled in the art, that although a tractor trailer 10 is shown and described with respect to the various examples described herein, that any suitable vehicle requiring a cost-effective solution to providing ambient illumination to an interior chamber within a vehicle or a trailer to the vehicle is contemplated. Further, certain aspects of the skylight assembly 18 described herein may be implemented in non-vehicular aspects, including but not limited to mobile homes, modular classrooms, temporary housing, etc.

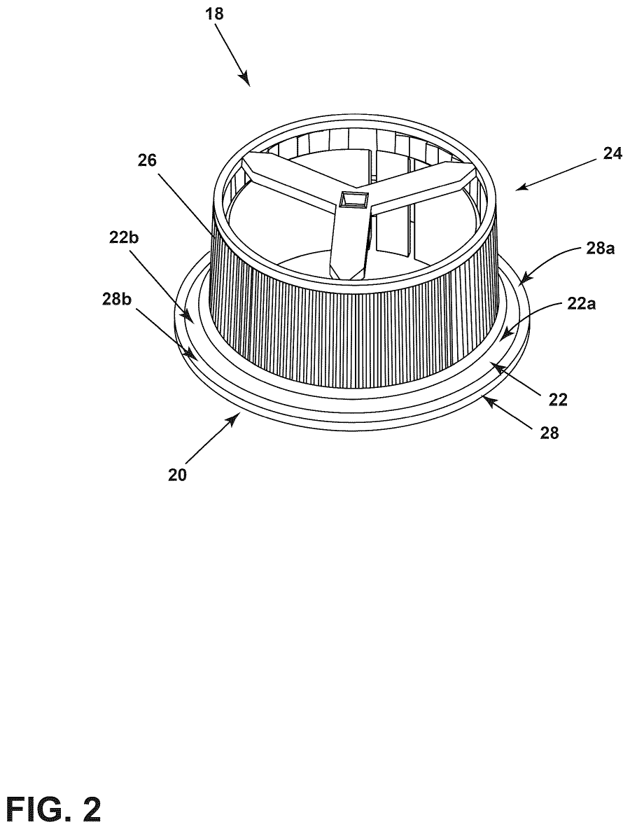

Turning now to FIG. 2, a perspective view of the skylight assembly 18 according to one example is illustrated. The skylight assembly 18 comprises at least a lens portion 20, a gasket 22, and a retainer 24. The lens portion 20 is configured to be positioned on one side of the sidewall 16 of the trailer 14, by way of example an exterior of the sidewall 16. The retainer 24 is configured to be positioned on another side of the sidewall 16, by way of example an interior of the sidewall 16. The retainer 24 may be configured to engage a portion of the lens portion 20 with the gasket 22 positioned axially therebetween to provide a sealing function between the interior of the trailer 14 and an exterior of the trailer 14. The gasket 22 provides protection from external elements.

It will be understood by one skilled in the art that the gasket 22 is a well-known component and can have a number of configurations to provide a sealing function to the skylight assembly 18. Various modifications and configurations of the gasket 22 can be provided and contemplated by one skilled in the art.

The lens portion 20 comprises an annular sidewall 26 having one end terminating in a flange 28. The flange 28 extends circumferentially from the annular sidewall 26. The gasket 22 is coincident with the flange 28. In one example, the flange 28 has an interior-facing surface 28a provided with an adhesive portion 28b. In another example, the gasket 22 has an interior-facing surface 22a provided with an adhesive portion 22b.

Either adhesive portion 22b, 28b may extend about an entire circumference of the flange 28, or in portions of adhesive that circumferentially-extends therealong. It will be understood by one skilled in the art that the adhesive portion 22b, 28b can optionally be provided with a detachable covering of its own for shipment and packaging purposes that can be removed at the time of installation to expose a high adhesive coating thereon.

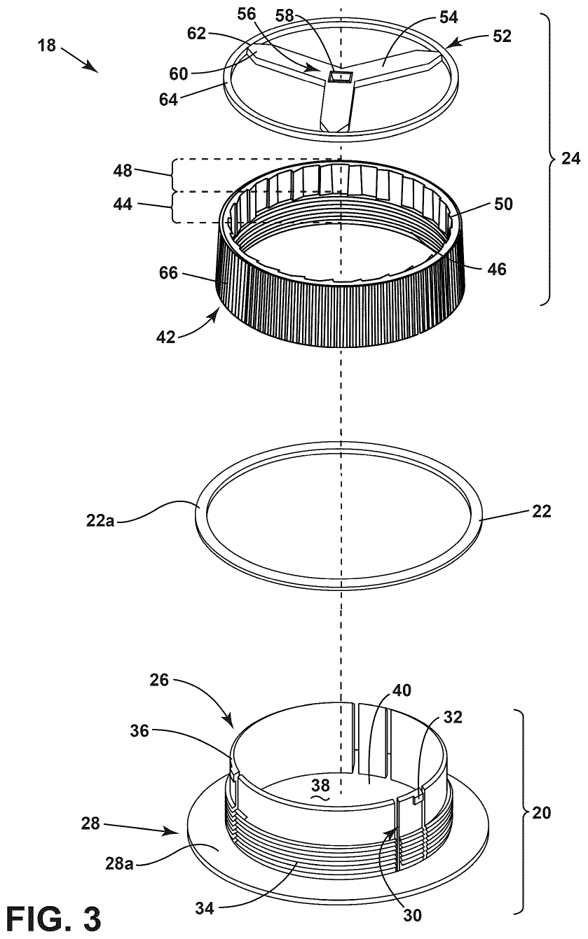

Turning to FIG. 3, an exploded view of the skylight assembly 18 along a central axis is shown wherein the lens portion 20 is shown at a bottom portion of FIG. 3, the gasket 22 is positioned in a center portion of FIG. 3, and the retainer is shown at an upper portion of FIG. 3. It will be understood that the particular configuration and arrangement of the lens portion 20, gasket 22, and retainer 24 are shown for illustrative purposes only and no limitation should be taken from the arrangement shown in FIG. 3. In addition, although the skylight assembly 18 is shown having a circular configuration in the various embodiments shown in the specification and drawings and various shape-considering terms like “annular” are used herein, other shapes and design preferences would be apparent to one skilled in the art, and the particular configuration shown by example in the specification and drawings herein should not be construed as limiting.

The annular sidewall 26 may include a plurality of angularly spaced securing tabs 30 coaxial about the central axis. By way of example, the securing tabs are three securing tabs 30 spaced angularly and equidistantly around the periphery of the annular sidewall 26. One or more of the securing tabs 30 includes a protrusion 32 extending circumferentially outward from a terminal end 36 of the annular sidewall 26 opposite the flange 28. The protrusion 32 can be provided with a ramped surface thereon, the function of which will be described below. A portion of an exterior surface of the annular sidewall 26 can have a series of threads 34 provided thereon. In the example shown in FIG. 3, the threads 34 on the annular sidewall 26 extend approximately half the axial extent of an exterior of the annular sidewall 26. It will be understood that an amount of extension of the threads 34 on the annular sidewall 26 is shown by example and is not meant to be limiting. Any additional or less amount of threads on the extent of the annular sidewall 26 is contemplated.

In one example, the terminal end 36 of the annular sidewall 26, opposite from the flange 28, is a chamfered edge angled in a ramp configuration toward an interior portion of the annular sidewall 26. The terminal end 36 can provide deflection assistance to the annular sidewall when inserted into a suitably-sized opening. The annular sidewall 26 of the lens portion 20 defines an interior chamber 38 within the periphery of the annular sidewall 26. A lens 40 is provided on the lens portion 20 to form a base portion of the interior chamber 38 of the annular sidewall 26. The lens 40 can have a suitably transparent, translucent, or opaque surface thereon as would be selected for the particular function of the skylight assembly 18.

The retainer 24 comprises a retainer sidewall 42 in radially-sized alignment with the annular sidewall 26 of the lens portion 20. In other words, the retainer sidewall 42 is configured to circumscribe the annular sidewall 26 when assembled. The retainer sidewall 42 has an interior surface facing the exterior of the annular sidewall 26 when assembled. In one example the interior surface includes a first portion 44 and a second portion 48. The first portion 44 comprises a series of threads 46 in matching alignment with the threads 34 on the annular sidewall 26 of the lens portion 20. The second portion 48 comprises a series of axially extending detents 50 having inwardly-extending ramped portions. Each detent 50 generally comprises a ramped surface on a leading edge and a retention surface on a trailing edge configured to engage with the protrusions 32 on the annular sidewall 26 of the lens portion 20. While the series of threads 46 is illustrated as extending approximately halfway through an axial distance of the annular sidewall 26 and a remainder of the axial distance of the retainer sidewall 42 is shown as having the detents 50, it will be understood by one skilled in the art that the axial extent of the first portion 44 having the threads 46 and the axial extent of the second portion 48 having the detents 50 can be changed to suit the installation requirements of the skylight assembly 18. For example, the thickness of the sidewall 16 of the trailer 14 will influence an extent of the first and second portions 44, 48 and enable proper installation of the skylight assembly 18.

A torque limiting member 52 may be provided on a periphery of the retainer sidewall 42. The torque limiting member 52 generally comprises a plurality of detachable blades 54 integrally joined at a central portion 56. The central portion 56 of the torque limiting member 52 is provided with a tool insertion aperture 58. In one example, the tool insertion aperture 58 is sized to receive a standard bit of a generally well-known hand tool that can provide rotational movement to the torque limiting member 52, and thereby to an entirety of the retainer 24 when the hand tool provides rotational movement to the torque limiting member 52. Outer axial tips 60 of each of the detachable blades 54 may include a reduced thickness portion 62 with a predetermined shear strength.

The torque limiting member 52 can be integrally formed with the retainer sidewall 42, or formed as a separate piece with a rim portion 64 as illustrated. The rim portion 64 may be attached to the periphery of the retainer sidewall 42 in a manner that would be apparent to one skilled in the art. An outer periphery of the retainer sidewall 42 can be provided with a series of raised ridges 66 that can function as a grip aid for a user to grasp the outer surface of the retainer 24 to rotate it into place as part of the assembly and installation of the skylight assembly 18. The raised ridges 66 can also provide gripping assistance during removal of the retainer 24 from the lens portion 20.

To ensure proper installation, suitably-sized threads 34 on the annular sidewall 26 correspond with the threads 46 on the retainer sidewall 42. When a torque imparted on the retainer 24 reaches the predetermined shear strength, the reduced thickness portion 62 of the outer axial tips 60 on each of the detachable blades 54 will release from their corresponding mounting to the periphery of the retainer sidewall 42 (e.g., the rim portion 64) of the retainer 24 and the plurality of detachable blades 54 and the central portion 56 will release from the remainder of the retainer 24.

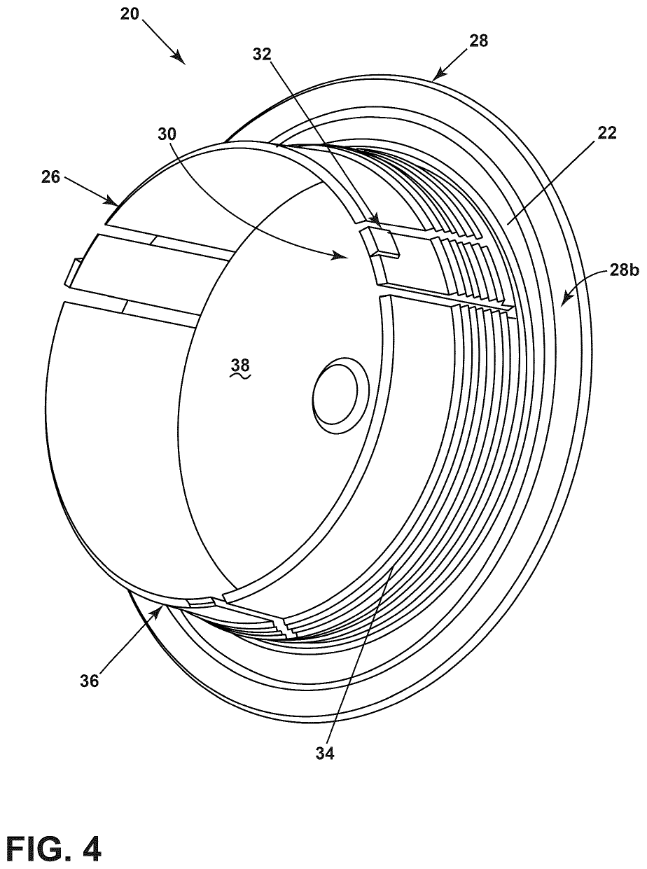

FIG. 4 is a perspective view of the lens portion 20 of the skylight assembly 18 from FIGS. 2 and 3.

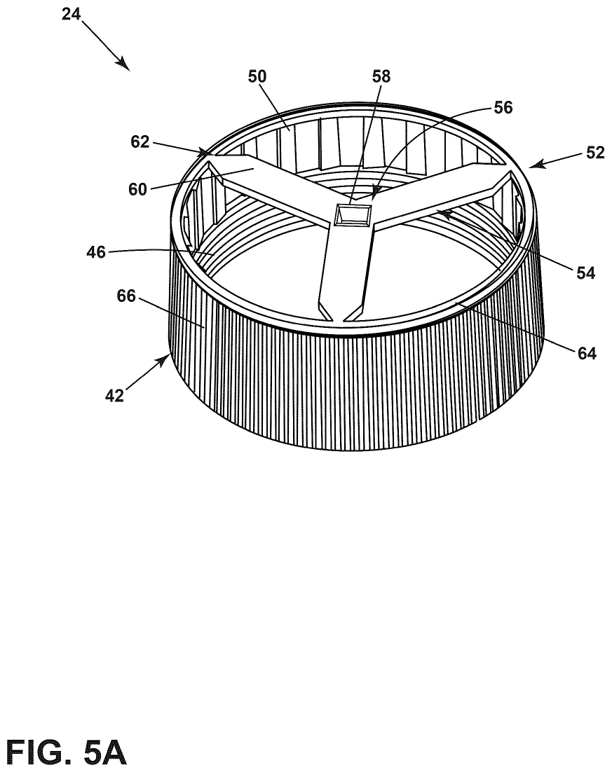

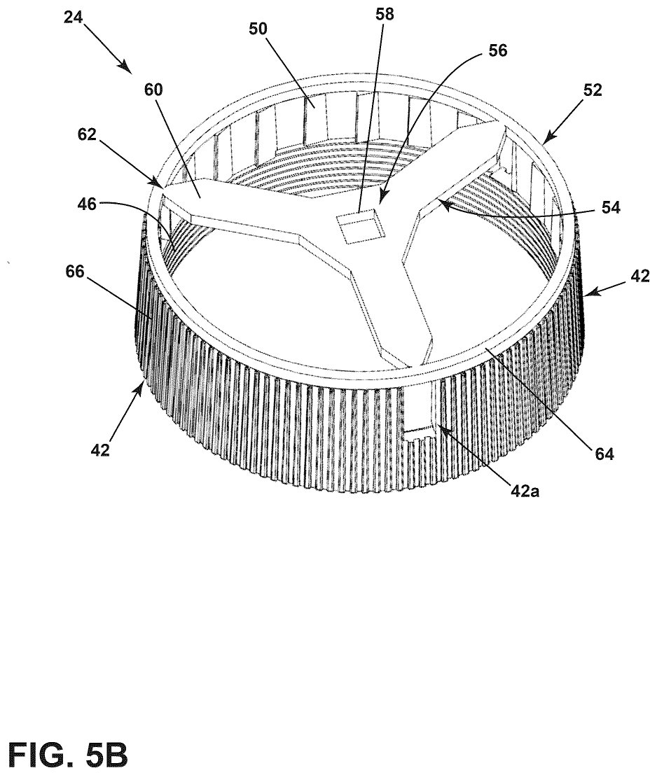

FIG. 5A is a perspective view of an assembled retainer 24 of the skylight assembly 18 from FIGS. 2 and 3.

FIG. 5B is an alternative example of the retainer 24 from FIG. 5A. Reference numerals have been retained with respect to the components from the retainer 24 of FIG. 5A. A central portion 56 of the torque limiting member 52 is enlarged to provide additional reinforcement for the skylight assembly 18. The additional reinforcement allows for higher torques to be imparted on the retainer 24 and for the skylight assembly 18 to handle higher shear strengths to encourage detachment of the detachable blades 54 from the retainer 24. By way of example, the retainer 24 may include access ports 42a extending through the retainer sidewall 42. The access ports 42a enable a one-piece mold during manufacturing.

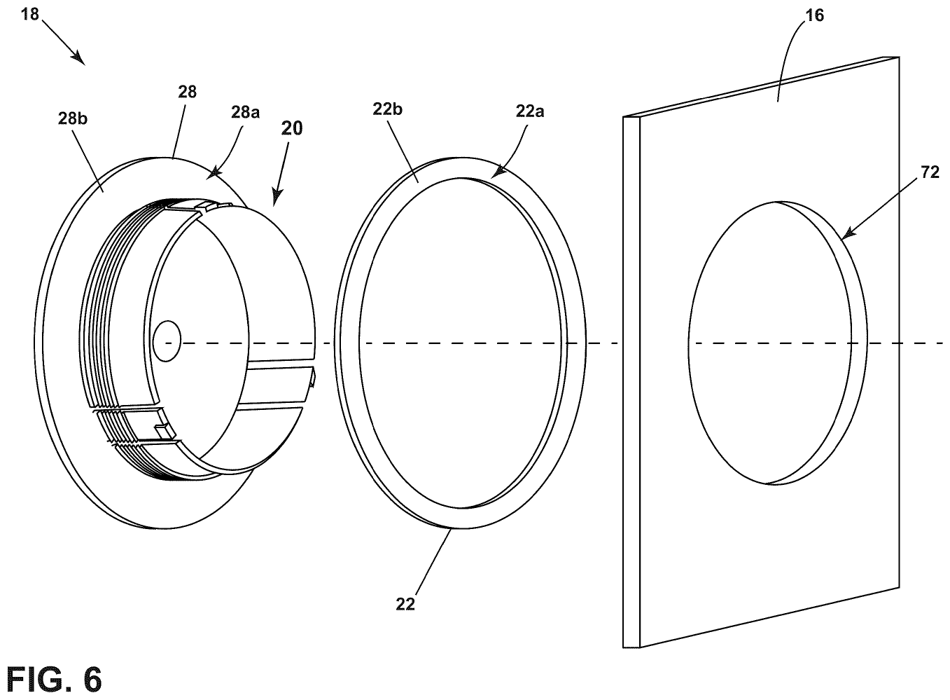

Turning to FIG. 6, the installation of the skylight assembly 18 into an opening, or aperture 72, on the sidewall 16 of the trailer 14 will now be described. Installation of the skylight assembly 18 into a suitable opening in the sidewall 16 of a trailer 14 as described herein can be performed by a single individual. In FIG. 6, the lens portion 20 is shown in axial alignment with an aperture 72 of the sidewall 16.

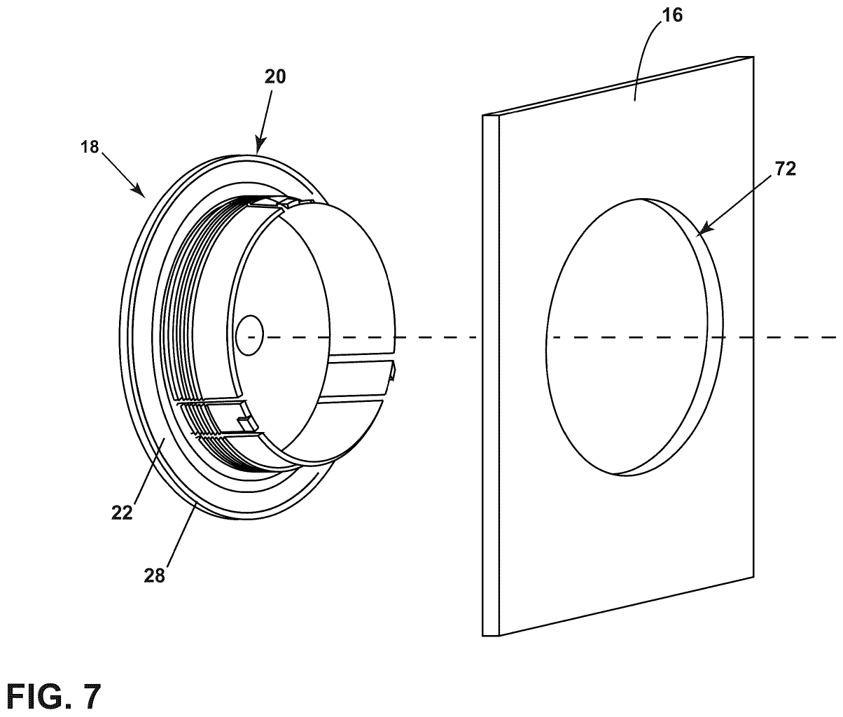

In one installation step, any adhesive covering is removed from the adhesive portion 22b, 28b on the flange 28 and/or the gasket 22. The gasket 22 is placed along the flange 28. The gasket 22 is illustrated in place in FIG. 7. The lens portion 20 is then aligned with the aperture 72 on the sidewall 16 of the trailer 14 as illustrated in FIGS. 6 and 7.

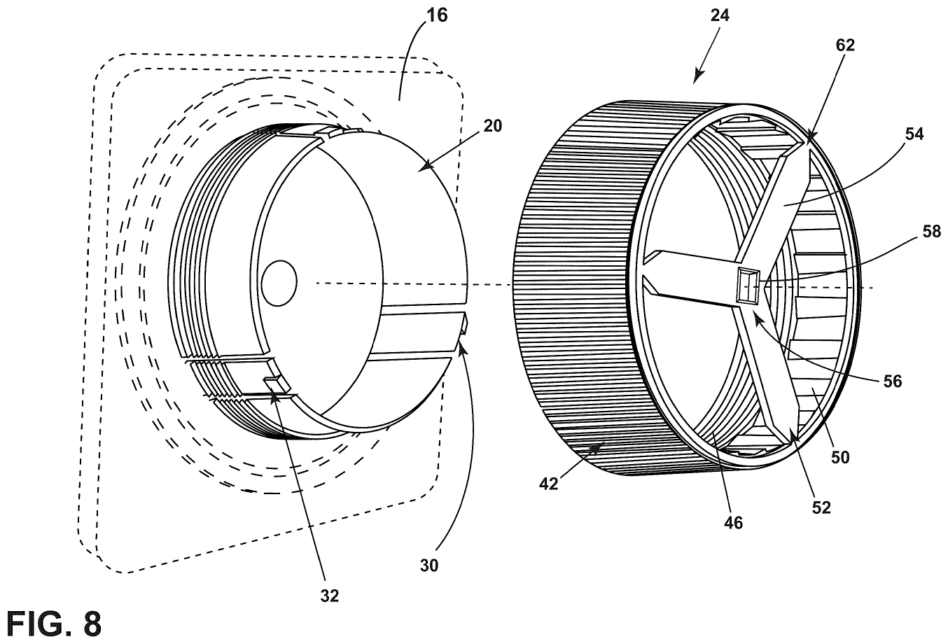

Turning to FIG. 8, in another installation step the lens portion 20 is inserted into the opening defined by the aperture 72 in the sidewall 16 of the trailer 14. The flange 28 is then pressed against the sidewall 16 so that the remaining adhesive portion 28b (not covered by the gasket 22) on the interior-facing surface 28a can adhere to the outer surface of the sidewall 16 of the trailer 14. The adhesive portion 28b on the flange 28 holds the lens portion 20 in place against the sidewall 16 of the trailer 14.

In another example, the adhesive portion 22b of the gasket 22 adheres to the outer surface of the sidewall 16 of the trailer 14 to temporarily hold the skylight assembly 18 in place. It will be understood by one skilled in the art that the gasket 22 is provided surrounding the annular sidewall 26 of the lens portion 20 and provides a sealing function between the interior of the flange 28 with the exterior of the sidewall 16 of the trailer 14.

In another installation step, the retainer 24 is brought into axial alignment with the annular sidewall 26 of the lens portion 20 that is now accessible within the trailer 14 through the opening defined by the aperture 72 in the sidewall 16 of the trailer 14.

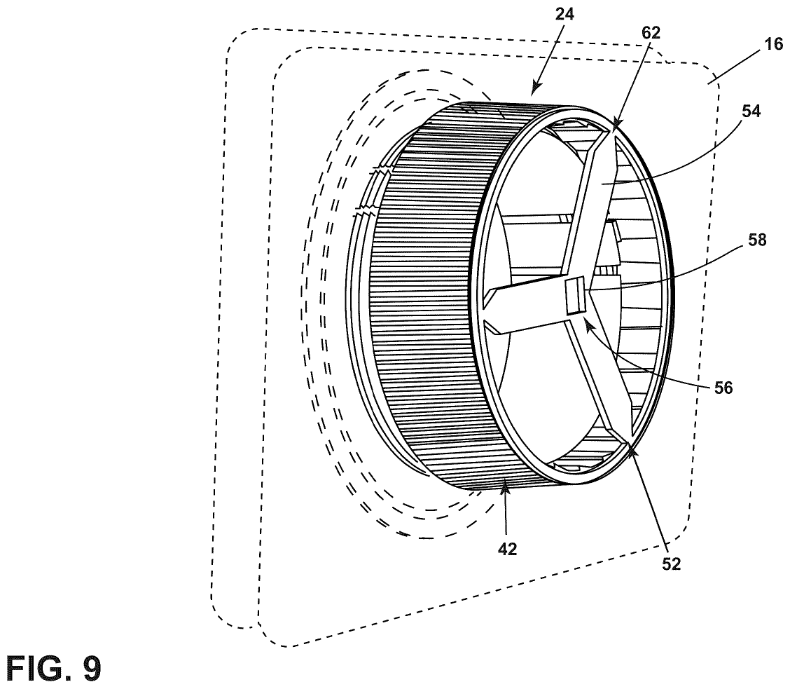

Turning to FIG. 9, in yet another installation step, the retainer 24 is threaded onto the annular sidewall 26 of the lens portion 20 by engaging the threads 46 on the interior of the retainer sidewall 42 onto the threads 34 on the exterior of the annular sidewall 26 of the lens portion 20.

In one example the retainer 24 is tightened onto the lens portion 20 by continuing to rotate the retainer 24 with respect to the lens portion 20 so that the threads 46 on the interior of the retainer 24 engage with the threads 34 on the exterior of the annular sidewall 26 of the lens portion 20 until the retainer 24 is sufficiently tightened with respect to the lens portion 20 with the periphery of the aperture 72 holding the retainer 24 and the lens portion 20.

Referring to both FIGS. 8 and 9, as the retainer 24 is rotated and threaded onto the lens portion 20, the protrusions 32 of each spaced securing tab 30 can successively engage with the plurality of detents 50 provided on the second portion 48 of the interior of the retainer sidewall 42. This can provide an audible sound as the retainer 24 is rotated with respect to the lens portion 20. The engagement of the detents 50 of the retainer 24 with respect to the protrusions 32 also prevents “backtracking” (i.e., counterrotation) of the retainer 24 with respect to the lens portion 20. This prevents inadvertent disengagement of the retainer 24 with respect to the lens portion 20, such as a result of vibrations imparted by the trailer 14 to the sidewall 16 during conventional operation of the tractor trailer 10. Additionally, proper compression of the gasket 22 (illustrated in dashed line) for sealing purposes during and after installation of the retainer 24 to the lens portion 20 can occur without a specialized tool or complicated installation steps. The torque limiting member 52 permits the retainer 24 to compress the gasket 22 with respect to the lens portion 20 and the sidewall 16 (e.g., an exterior of the trailer 14) at a desirable pressure to provide sealing against intrusion by environmental elements.

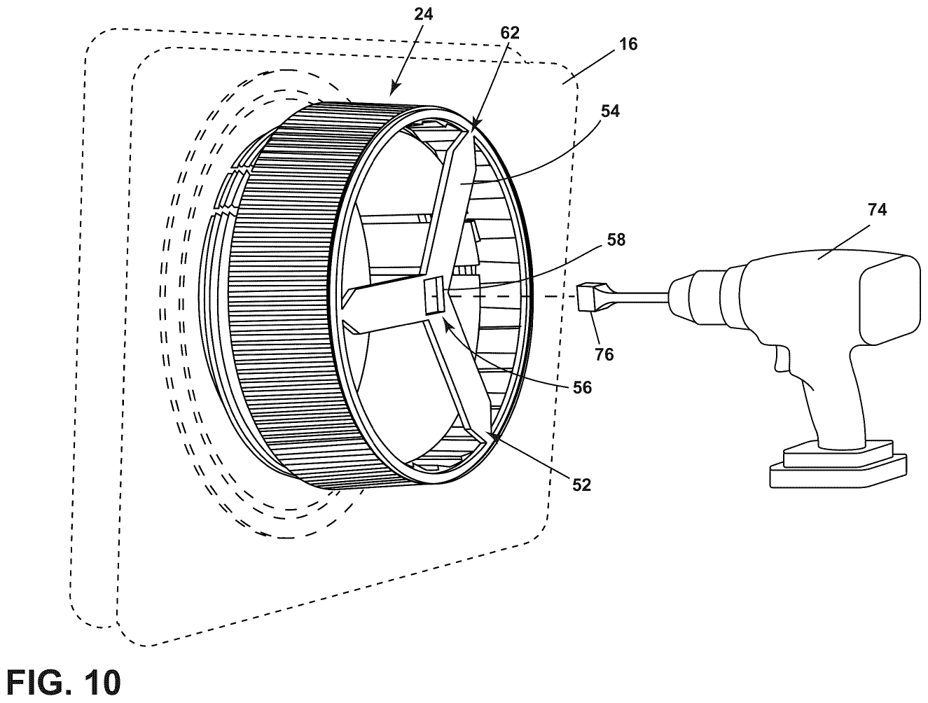

Turning to FIG. 10, in another example, the retainer is tightened with a hand tool 74 suitable for applying rotation, such as a hand drill, with a standard bit attachment. The tool insertion aperture 58 of the torque limiting member 52 is configured to receive a bit attachment 76 of the hand tool 74. The hand tool 74 imparts a rotational movement of the retainer 24 with respect to the lens portion 20, thereby engaging the threads 46 on the interior of the retainer sidewall 42 onto the threads 34 on the exterior of the annular sidewall 26 of the lens portion 20. The use of the hand tool 74 to thread the retainer 24 onto the lens portion 20 is shown in FIG. 10.

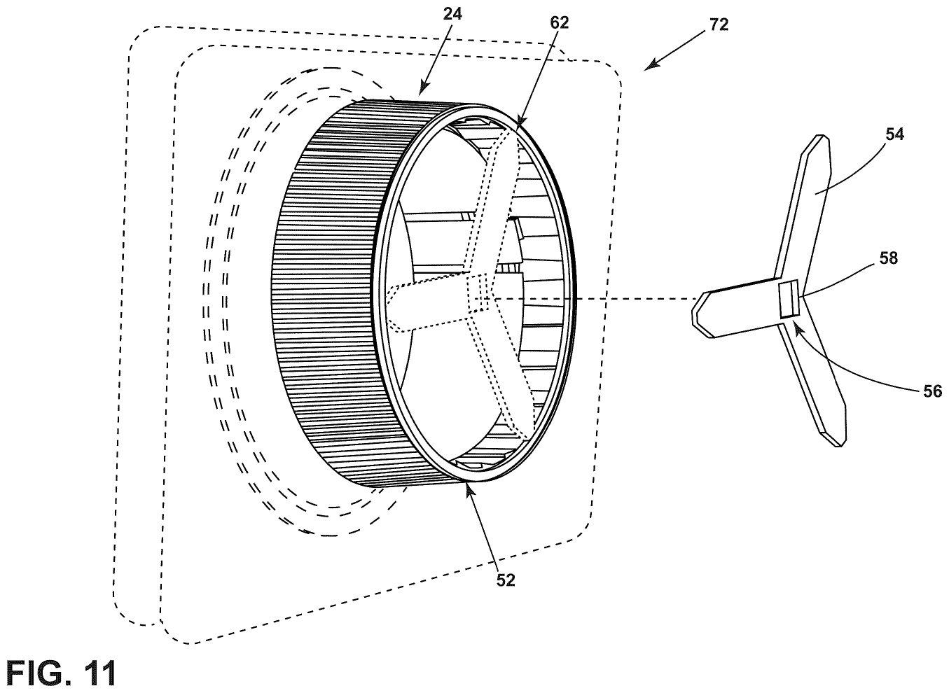

Turning to FIG. 11, as the threads 34, 46 become increasingly engaged and the friction between the threads 34, 46 increases, the predetermined shear strength will eventually be exceeded. When the predetermined shear strength is met and/or exceeded the detachable blades 54 of the central portion 56 will detach at the reduced thickness portion 62.

FIG. 12 is a profile view of the skylight assembly 18. For clarity, the sidewall 16 is not shown in cross-section.

To remove the skylight assembly 18, removal of the securing tabs 30 occurs. The securing tabs 30 may be removed with, by way of example a suitable hand tool, such as a flathead screwdriver, to either pry back or snap off the securing tabs 30 from the retainer 24. Once the securing tabs 30 are removed disengagement of the retainer 24 from the lens portion 20 is possible. In one example, the retainer 24 is counterrotated with respect to the lens portion 20 to unthread the retainer 24 from the lens portion 20.

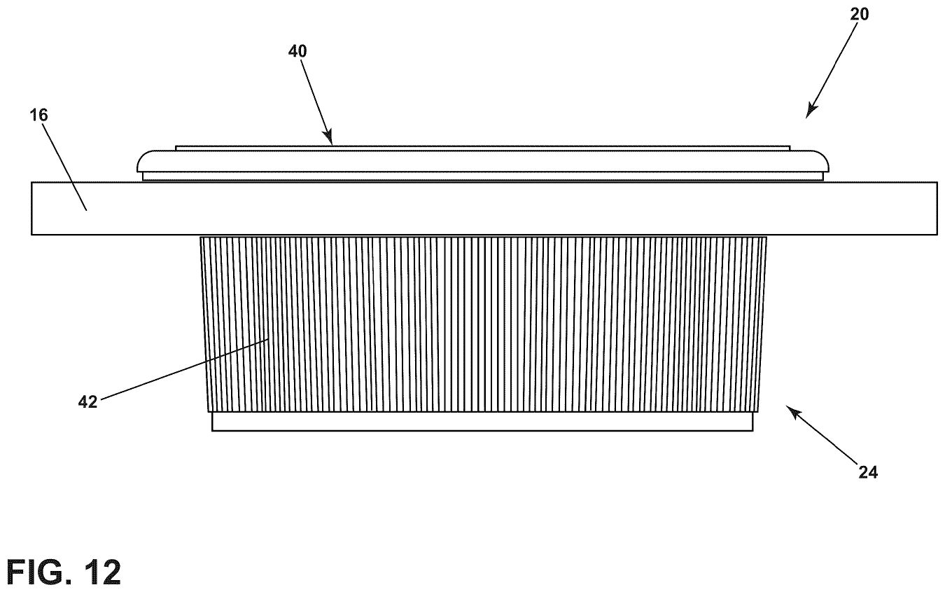

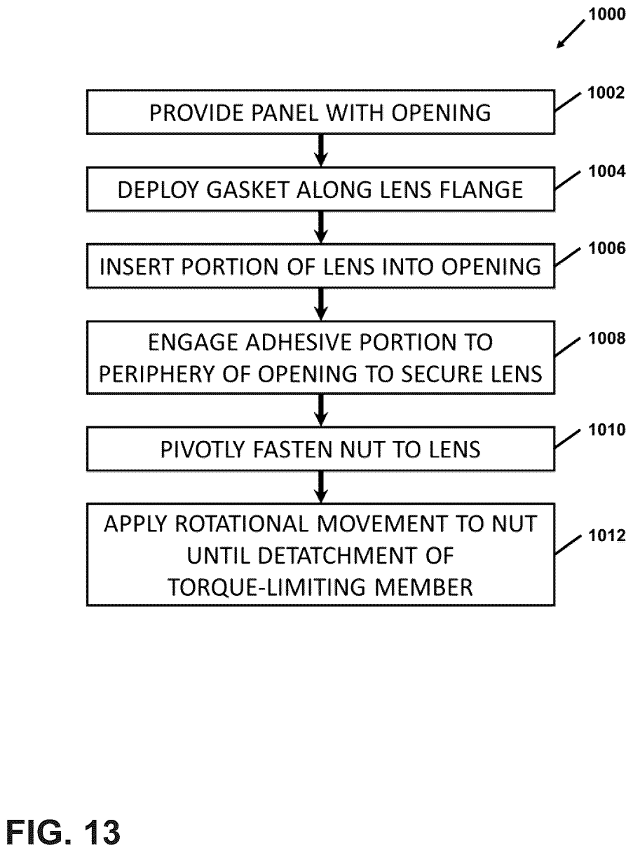

FIG. 13 illustrates a method 1000 of installing the skylight assembly 18 according to one example herein. At block 1002 a panel, (e.g., sidewall 16) with an opening (e.g., aperture 72) is provided. At block 1004, the gasket 22 may be deployed along the flange 28. At block 1006, the lens portion 20, an in particular the annular sidewall 26, is inserted into the opening. At block 1008, the adhesive portion 22b, 28b is engaged to a periphery of the opening (e.g., the exterior of sidewall 16) to secure the skylight assembly 18. At block 1010, rotational movement is applied to a nut (e.g., the retainer 24) until a portion of the torque limiting member 52 (e.g., the central portion 56) becomes detached.

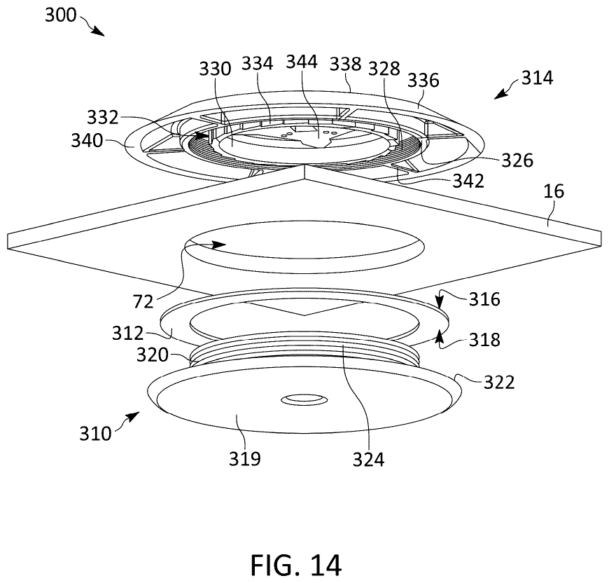

FIG. 14 is an exploded view of a skylight assembly 300 according to another aspect of the disclosure herein. The skylight assembly 300 includes a lens portion 310, a gasket 312, and a retainer 314. The gasket 312 includes an adhesive side 316 and a non-adhesive side 318. The non-adhesive side 318 faces the lens portion 310. The adhesive side 316 may include a liner for removal prior to installation. The sidewall 16 with the aperture 72 is illustrated to show orientation of the parts of the skylight assembly 300 when installed, where the lens portion 310 is located on an exterior of the sidewall 16 and the retainer 314 is located on an interior of the sidewall 16, e.g., within a trailer.

The lens portion 310 includes a lens 319 and an annular sidewall 320 having one end terminating in a flange 322. The flange 322 extends circumferentially from the annular sidewall 320. The flange 322 defines an interior side facing the sidewall 16 when assembled. An exterior portion of the annular sidewall 320 facing the interior side of the flange 322 includes a first series of threads 324. It will be understood that an amount of the threads 324 on the annular sidewall 320 is shown by example and is not meant to be limiting. Any additional or less amount of threads on the extent of the annular sidewall 320 is contemplated.

The retainer 314 includes an outer retainer sidewall 326 configured to circumscribe the annular sidewall 320 when assembled. The outer retainer sidewall 326 has an interior surface facing the exterior of the annular sidewall 320 when assembled. In one example the interior surface includes a series of threads 328 in matching alignment with the threads 324 on the annular sidewall 320 of the lens portion 310.

The retainer 314 includes an inner retainer sidewall 330 spaced from the outer retainer sidewall 326 to define a channel 332 in radially-sized alignment with the annular sidewall 320 of the lens portion 310. The annular sidewall 320 is configured to circumscribe the inner retainer sidewall 330 when assembled. The inner retainer sidewall 330 has an interior surface facing the channel 332. In one example the interior surface includes a series of axially extending detents 334 having inwardly-extending ramped portions.

The retainer 314 includes a flared wall 336 spaced from the outer retainer sidewall 326. The flared wall 336 flares circumferentially outwardly from a top 338 of the retainer 314 to a flared end 340. A set of spokes 342 extend from the outer retainer sidewall 326 to the flared wall 336 to provide structural stability to the flared wall 336.

A torque limiting member 344 is provided at the top 338 of the retainer 314.

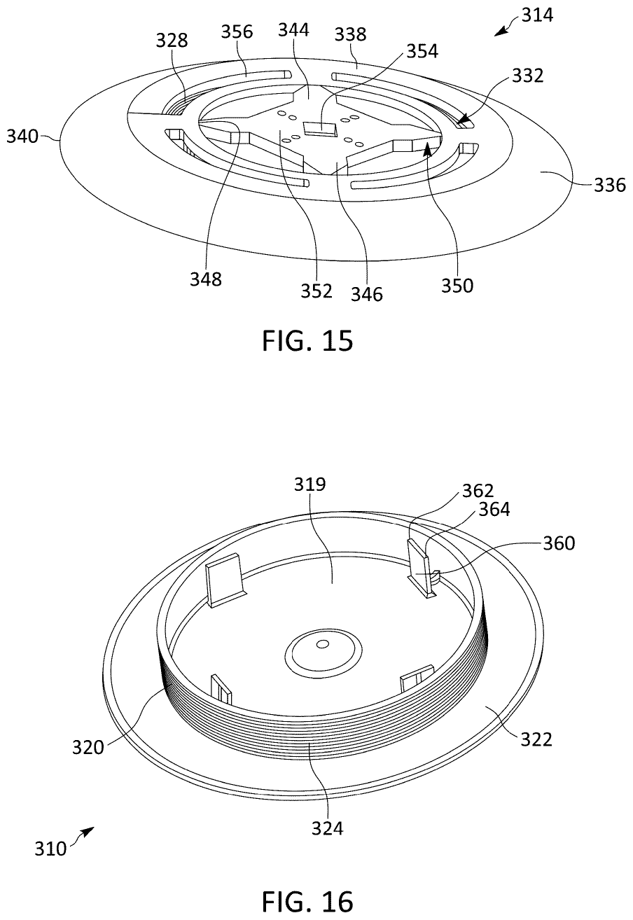

FIG. 15 illustrates the retainer 314 in a perspective view looking at the top 338 of the retainer 314. It can more easily be seen that the torque limiting member 344 includes a plurality of detachable blades 346. Outer axial tips 348 of each of the detachable blades 346 may include a reduced thickness portion 350 with a predetermined shear strength. The reduced thickness portion 350 is meets a rim portion, by way of example the inner retainer sidewall 330. The detachable of blades 346 are joined at a central portion 352 opposite the outer axial tips 348. The central portion 352 includes a tool insertion aperture 354 defining a center of the retainer 314. In one example, the tool insertion aperture 354 is sized to receive a standard bit of a generally well-known hand tool that can provide rotational movement to the torque limiting member 344, and thereby to an entirety of the retainer 314 when the hand tool provides rotational movement to the torque limiting member 344.

A set of apertures 356 are aligned with channel 332. The set of apertures 356 provide a line of site to the lens portion 310 during assembly.

FIG. 16 is a perspective view of the lens portion 310 facing the interior side of the flange 322. A set of securing tabs 360 are provided on an interior side of the annular sidewall 320. While four securing tabs 360 are illustrated more or less securing tabs 360 are contemplated. The set of securing tabs 360 are spaced from the interior side of the annular sidewall 320 and oriented at an angle where one end 362 of each tab is closer to the interior side than another end 364 of each tab. The set of securing tabs 360 face the series of axially extending detents 334 when assembled.

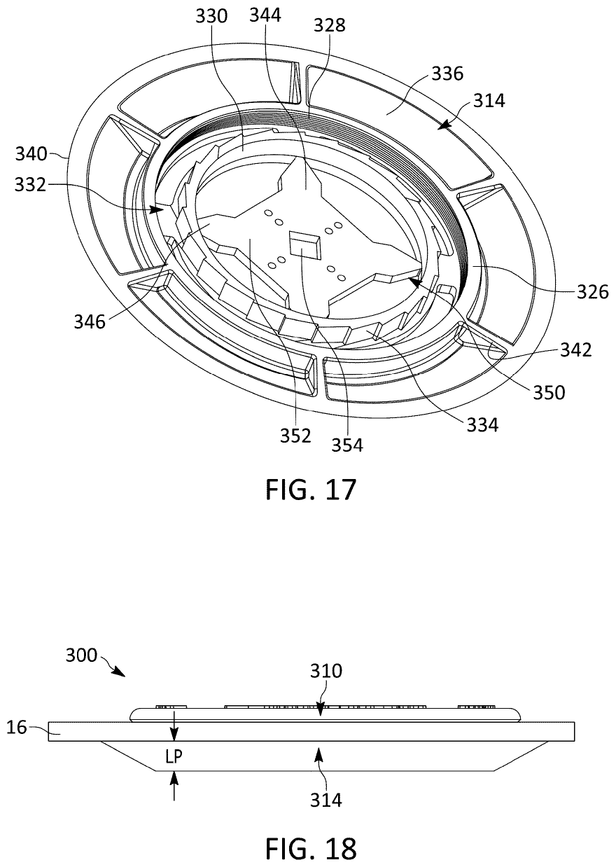

FIG. 17 illustrates the retainer 314 in a perspective view looking at a bottom of the retainer 314. It can more easily be seen that each detent 334 generally comprises a ramped surface on a leading edge and a retention surface on a trailing edge. The detents 334 are configured to engage with the set of securing tabs 360 of the lens portion 20. As the retainer 314 is rotated and threaded onto the lens portion 310, the set of securing tabs 360 of the lens portion 310 can successively engage with the plurality of detents 334 of the retainer 314. This can provide an audible sound as the retainer 314 is rotated with respect to the lens portion 310. The engagement of the detents 334 of the retainer 314 with respect to the set of securing tabs 360 also prevents “backtracking” (i.e., counterrotation) of the retainer 314 with respect to the lens portion 310. This prevents inadvertent disengagement of the retainer 314 with respect to the lens portion 310, such as a result of vibrations imparted by the trailer 14 to the sidewall 16 during conventional operation of the tractor trailer 10.

FIG. 18 illustrates a profile of the skylight assembly 300. For clarity, the sidewall 16 is not shown in cross-section. When compared to the skylight assembly 18 of FIG. 12, the skylight assembly 300 defines a lower profile (“LP”) within the trailer 14. In other words, the skylight assembly 300 protrudes less into an interior of the trailer 14 than the skylight assembly 18 of FIG. 12.

To remove the skylight assembly 300, removal of the set of securing tabs 360 occurs. The set of securing tabs 360 may be removed with, by way of example a suitable hand tool, such as a flathead screwdriver, to either pry back or snap off the securing tabs 360 from the retainer 314. Once the set of securing tabs 360 are removed disengagement of the retainer 314 from the lens portion 310 is possible. In one example, the retainer 314 is counterrotated with respect to the lens portion 310 to unthread the retainer 314 from the lens portion 310.

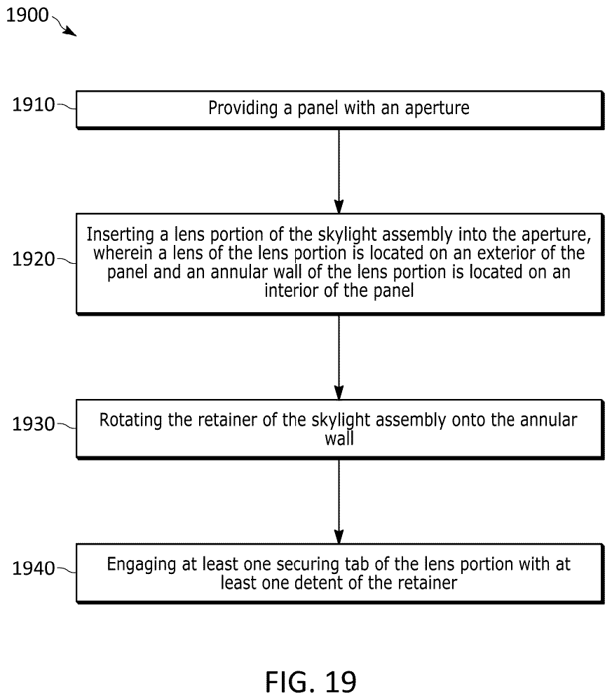

FIG. 19 illustrates a method 1900 of installing the skylight assembly 300 according to one example herein. At block 1910 a panel, (e.g., sidewall 16) with an opening (e.g., aperture 72) is provided. At block 1920, the lens portion 310 is inserted into the aperture such that a portion (e.g., the lens 319) is located on an exterior of the panel and the annular sidewall 320 is located on an interior of the panel. At block 1930, the retainer 314 is rotated onto the annular sidewall 320 (e.g., with the torque limiting member 344). At block 1940 engaging at least one securing tab (e.g., from the set of securing tabs 360) of the lens portion 310 with at least one detent (e.g., the detents 334) of the retainer 314.

To the extent not already described, the different features and structures of the various aspects can be used in combination, or in substitution with each other as desired. That one feature is not illustrated in all of the examples is not meant to be construed that it cannot be so illustrated but is done for brevity of description. Thus, the various features of the different aspects can be mixed and matched as desired to form new aspects, whether or not the new aspects are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Implementations of the present disclosure are disclosed in the following clauses:

Clause 1. A skylight assembly for a vehicle, the skylight assembly comprising: a first portion comprising a lens and a first annular wall defining a central axis and having at least one securing tab; and a second portion comprising a second annular wall having at least one detent configured to engage with at least a portion of the at least one securing tab.

Clause 2. The skylight assembly of clause 1, wherein the at least one securing tab comprises a protrusion and the at least one detent comprises a ramped surface and a retention surface for engaging with the protrusion.

Clause 3. The skylight assembly of any preceding clause, wherein the at least one securing tab is a plurality of securing tabs coaxial with the central axis and the at least one detent is a plurality of detents coaxial with the central axis.

Clause 4. The skylight assembly of any preceding clause, wherein the first annular wall comprises a torque limiting member having an aperture coaxial with the central axis.

Clause 5. The skylight assembly of clause 4, wherein at least a portion of the torque limiting member detaches when a torque imparted on the second portion reaches or exceeds a predetermined shear strength.

Clause 6. The skylight assembly of clause 4, wherein the torque limiting member comprises a plurality of blades extending radially from the aperture at a central portion of the torque limiting member.

Clause 7. The skylight assembly of clause 6, wherein each of the plurality of blades extends from the central portion to a rim portion axially aligned with the second annular wall.

Clause 8. The skylight assembly of clause 7, wherein each of the plurality of blades meets the rim portion at an outer axial tip, and wherein the outer axial tip comprises a reduced thickness portion having a predetermined shear strength.

Clause 9. A skylight assembly for a vehicle, the skylight assembly comprising: a first portion comprising a lens and a first annular wall defining a central axis; and a second portion comprising a second annular wall and a torque limiting member having an aperture coaxial with the central axis; wherein at least a portion of the torque limiting member detaches when a torque imparted on the second portion reaches or exceeds a predetermined shear strength.

Clause 10. The skylight assembly of clause 10, wherein the first annular wall comprises at least one securing tab and the second annular wall comprises at least one detent configured to engage with at least a portion of the at least one securing tab.

Clause 11. The skylight assembly of clause 10, wherein the at least one securing tab comprises a protrusion and the at least one detent comprises a ramped surface and a retention surface for engaging with the protrusion.

Clause 12. The skylight assembly of clauses 10-11, wherein the at least one securing tab is a plurality of securing tabs coaxial with the central axis and the at least one detent is a plurality of detents coaxial with the central axis.

Clause 13. The skylight assembly of any of clauses 9-12, wherein at least a portion of the torque limiting member detaches when a torque imparted on the second portion reaches or exceeds a predetermined shear strength.

Clause 14. The skylight assembly of any of clauses 9-13, wherein the torque limiting member comprises a plurality of blades extending radially from the aperture at a central portion of the torque limiting member.

Clause 15. The skylight assembly of clause 14, wherein each of the plurality of blades extends from the central portion to a rim portion axially aligned with the second annular wall.

Clause 16. The skylight assembly of clause 15, wherein each of the plurality of blades meets the rim portion at an outer axial tip, and wherein the outer axial tip comprises a reduced thickness portion having a predetermined shear strength.

Clause 17. The skylight assembly of any preceding clause, wherein the first annular wall comprises a first series of threads and the second annular wall comprises a second series of threads rotatable about the first series of threads.

Clause 18. The skylight assembly of any preceding clause, wherein an exterior of the second annular wall comprises raised ridges.

Clause 19. The skylight assembly of any preceding clause, wherein the first annular wall terminates in a flange.

Clause 20. The skylight assembly of clause 19, further comprising a gasket coincident with the flange.

Clause 21. A method of installing a skylight assembly, the method comprising: providing a panel with an aperture; inserting a lens portion of the skylight assembly into the aperture, wherein a lens of the lens portion is located on an exterior of the panel and an annular wall of the lens portion is located on an interior of the panel; rotating a retainer of the skylight assembly onto the annular wall; and engaging at least one securing tab of the lens portion with at least one detent of the retainer.

Clause 22. The method of clause 21, further comprising engaging a torque limiting member of the retainer to rotate the retainer.

Clause 23. The method of clause 22, further comprising detaching a portion of the torque limiting member from the skylight assembly when a torque imparted on the retainer reaches or exceeds a predetermined shear strength.

Clause 24. A method of installing a skylight assembly, the method comprising: providing a panel with an aperture; inserting a lens portion of the skylight assembly into the aperture, wherein a lens of the lens portion is located on an exterior of the panel and an annular wall of the lens portion is located on an interior of the panel; engaging a torque limiting member of the retainer to rotate the retainer; and rotating a retainer of the skylight assembly onto the annular wall.

Clause 25. The method of clause 24, further comprising engaging at least one securing tab of the lens portion with at least one detent of the retainer.

Clause 26. The method of clauses 24-25, further comprising detaching a portion of the torque limiting member from the skylight assembly when a torque imparted on the retainer reaches or exceeds a predetermined shear strength.

What is claimed is:

1. A skylight assembly for a vehicle, the skylight assembly comprising:
a first portion comprising a lens and a first annular wall defining a central axis and having at least one securing tab; and
a second portion comprising a second annular wall having at least one detent configured to engage with at least a portion of the at least one securing tab.

2. The skylight assembly of claim 1, wherein the at least one securing tab comprises a protrusion and the at least one detent comprises a ramped surface and a retention surface for engaging with the protrusion.

3. The skylight assembly of claim 1, wherein the at least one securing tab is a plurality of securing tabs coaxial with the central axis and the at least one detent is a plurality of detents coaxial with the central axis.

4. The skylight assembly of claim 1, wherein the first annular wall comprises a torque limiting member having an aperture coaxial with the central axis.

5. The skylight assembly of claim 4, wherein at least a portion of the torque limiting member detaches when a torque imparted on the second portion reaches or exceeds a predetermined shear strength.

6. The skylight assembly of claim 4, wherein the torque limiting member comprises a plurality of blades extending radially from the aperture at a central portion of the torque limiting member.

7. The skylight assembly of claim 6, wherein each of the plurality of blades extends from the central portion to a rim portion axially aligned with the second annular wall.

8. The skylight assembly of claim 7, wherein each of the plurality of blades meets the rim portion at an outer axial tip, and wherein the outer axial tip comprises a reduced thickness portion having a predetermined shear strength.

9. The skylight assembly of claim 1, wherein the first annular wall comprises a first series of threads and the second annular wall comprises a second series of threads rotatable about the first series of threads.

10. The skylight assembly of claim 1, wherein an exterior of the second annular wall comprises raised ridges.

11. The skylight assembly of claim 1, wherein the first annular wall terminates in a flange.

12. The skylight assembly of claim 11, further comprising a gasket coincident with the flange.

13. A skylight assembly for a vehicle, the skylight assembly comprising:
a first portion comprising a lens and a first annular wall defining a central axis; and
a second portion comprising a second annular wall and a torque limiting member having an aperture coaxial with the central axis;
wherein at least a portion of the torque limiting member detaches when a torque imparted on the second portion reaches or exceeds a predetermined shear strength.

14. The skylight assembly of claim 13, wherein the first annular wall comprises at least one securing tab and the second annular wall comprises at least one detent configured to engage with at least a portion of the at least one securing tab.

15. The skylight assembly of claim 14, wherein the at least one securing tab comprises a protrusion and the at least one detent comprises a ramped surface and a retention surface for engaging with the protrusion.

16. The skylight assembly of claim 14, wherein the at least one securing tab is a plurality of securing tabs coaxial with the central axis and the at least one detent is a plurality of detents coaxial with the central axis.

17. The skylight assembly of claim 13, wherein the torque limiting member comprises a plurality of blades extending radially from the aperture at a central portion of the torque limiting member and wherein each of the plurality of blades meets a rim portion of the second portion at an outer axial tip, and wherein the outer axial tip comprises a reduced thickness portion having a predetermined shear strength.

18. A method of installing a skylight assembly, the method comprising:
providing a panel with an aperture;
inserting a lens portion of the skylight assembly into the aperture, wherein a lens of the lens portion is located on an exterior of the panel and an annular wall of the lens portion is located on an interior of the panel;
rotating a retainer of the skylight assembly onto the annular wall; and
engaging at least one securing tab of the lens portion with at least one detent of the retainer.

19. The method of claim 18, further comprising engaging a torque limiting member of the retainer to rotate the retainer.

20. The method of claim 19, further comprising detaching a portion of the torque limiting member from the skylight assembly when a torque imparted on the retainer reaches or exceeds a predetermined shear strength.
